(19) United States
(12) Patent Application Publication
(10) Pub. No.: US 2015/0038232 A1
(43) Pub. Date: Feb. 5, 2015

(54) Real time synchronization for real time fantasy sports player selection or change

(71) Applicants: Paul William Mikus, Coto de Caza, CA (US); Charles Randall Conner, Coto de Caza, CA (US)

(72) Inventors: Paul William Mikus, Coto de Caza, CA (US); Charles Randall Conner, Coto de Caza, CA (US)

(21) Appl. No.: 13/956,149

(22) Filed: Jul. 31, 2013

(51) Int. Cl. A63F 13/30

(52) U.S. Cl. CPC A63F 13/12
USPC 463/42

(57) ABSTRACT

This invention relates to fantasy leagues or contests to enable the ability to select or change players in real time during the contest. The ability to select or change players is accomplished by synchronization of real event game clocks to a master time clock. Synchronizing the master time clock to the real event game clock provides a chronologically correct method to enable prospective selections or changes. The synchronizing of clocks allows for specific amounts of actual player time to be selected by the fantasy operator during the actual event or prior to its start. The ability to play players in specific amounts of time results in the operator being able to select or change players in an endless number of combinations for teams in leagues or contests.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING

Not applicable

### BACKGROUND OF THE INVENTION

Fantasy sports have captured the imagination of sports fans. Fantasy sports allow the fan to become part of the experience by selecting individual players instead of whole teams to root for.

Organizing contests where the individual players points are added to other selected players to determine the outcome of the contest enables the focus on players instead of whole teams. This game structure places the fan in the position of General Manager, by selecting an endless combination in any sport to assemble and manager a team.

While Fantasy sports in its current embodiment have been wildly popular, it has an inherent limitation. Once games begin, the fan is relegated to the sidelines. For example, three of the most popular fantasy sports sites currently in operation are NFL Fantasy Football, ESPN Fantasy Football and Yahoo Fantasy Football. In each of those cases, player replacement or substitution during a real time event is not possible. All selections of players currently in fantasy sports require you to select them for the total playtime of the real event, with no ability to select the player for a portion of the time of the real event. Thus fantasy operators in these contests or leagues are unable to select or substitute players for specific amounts of time during the real time events.

Our invention corrects and improves on all fantasy sports play by overcoming this limitation. Our invention allows for selection of players for use in contests and leagues for specific amounts of time. Those amounts of time are selected in real time so the decisions by the fantasy operator to start or end play are made prior to knowing the outcome of the player's performance. This places the fantasy sports operator in the position of in game manager or coach during the game, deciding who should play and when they should play in real time.

In addition, selecting players for specific amounts of time allows for points to be awarded at a varying degree of multipliers rates. The varying degree of point multipliers adds another level of real time game decision making for the fantasy operator to consider.

U.S. Pat. Nos. 5,860,862 and 8,371,916 describe interactive fantasy systems. The interaction allows for substitution of players for a variety of reasons, including injury or performance.

U.S. Pat. No. 5,860,862 describes a system to trade players during a real event contest. The system describes a process of selecting or replacing players during events that have a single start time played in a day or over the course of several days. The manner of replacement is to trade based on the availability of players not drafted on other teams. This is disadvantageous because it is limited to events with single start times or replacement of players who have not been selected previously by all fantasy operators.

U.S. Pat. No. 8,371,916 utilizes a substitution time stamp to record player change. In this example, the replacement player is selected from already completed game period or periods. Thus real time substitution is limited to replacement players who have already completed play or are simultaneously playing at the same period of play as the player to be substituted.

Thus the current state of the art is limited to substituting players with a replacement player from a game event with that has a single start time or from a previously completed event. In both iterations, this is disadvantageous. When substituting a current player for performance of a replacement player who has already played, a competitive advantage occurs that renders the value of replacing a player impractical. In the application of a single game replacement, the replacement of players is limited to only those playing in that game or those not previously selected for play by all fantasy operators.

What does not exist, and would be an improvement on the current art is an ability to make real time selections or substitutions of players over multiple games starting at various times. This allows the fantasy operator to utilize all available players while maintaining the competitive integrity of not knowing the outcome when substituting.

### SUMMARY OF INVENTION

This invention relates to fantasy leagues or contests to enable the ability to select or change players in real time during the contest. The ability to select or change players is accomplished by synchronization of real event game clocks to a master time clock.

All real event game clocks used in the contest are synchronized to a master time clock prior to start of play. Each real event game clock represents the total playtime available for players in that contest. When a fantasy operator selects a player, a start signal is generated that marks the start time of play on the real event game clock. The start signal also marks the time on the master time clock. When a fantasy operator terminates the play of that player, an end signal is generated that marks both the real event game clock and the master time clock. The result is the selection of a player by the fantasy operator for a specific amount of time of play in any real event game that is part of a contest regardless of start times. The ability to play players in specific amounts of time results in the operator being able to select or change players in an endless number of combinations for teams in leagues or contests.

The master time clock provides a chronological reference point that marks the time player selections or changes are started or ended in relationship to the start and end times of the real game events the players are actually playing in. The master time clock determines the availability of players by verifying the start and end signals occur while the real event game clock is operating between its start and end times. The master clock ensures the selection occurs contemporarily and not after the play of the player selected. The result is players available for selection by fantasy operators are only those currently in play or scheduled to play in the future. This removes the ability to select a replacement player who has already completed play and whose results are know prior to selection.

One form of the invention is a fantasy sports system for operating a fantasy league. The fantasy sports system includes a fantasy access device such as; an internet web browser, smart phone device or tablet computer, a means to connect the device to a fantasy game server such as; a satellite connection, a fiber optic connection or any other internet connection commonly available, and a fantasy system game server that synchronizes real event game clocks to a master time clock, while determining the points derived by a player during the specific amount of time of play selected by the fantasy operator. The fantasy system allows operators to select players, and then change players at any position or make up of a team for a league so that the performance of the team is a function of the totals of all the specific amounts of time the fantasy operator has selected for use of the player or players during the real time events.

A second form of the present invention is a fantasy system for operating a contest. The contest may be of a variety of different lengths, ranging from one real time game play, series of plays or the entire event, to several real time game events over a number of days or weeks. The fantasy system includes a fantasy access device, a means to connect the device to a fantasy game server, and a fantasy system game server that synchronizes real event game clocks to a master time clock, while determining the points derived by a player during the specific amount of time of play selected by the fantasy operator. The fantasy system allows operators to select players, and or change players at any position or make up of a team for a contest so that the performance of the team in the contest is a function of the totals of all the specific amounts of time the fantasy operator has selected for use of the players during the real time events.

A third form of the present invention is a fantasy system for operating a league or a contest. The league or contest may be of a variety of different lengths, ranging from one real time game play, series of plays or the entire event, several real time game events over a number of days or weeks or over the course of a part of or the full season of the real time events. The fantasy system includes a fantasy access device, a means to connect the device to a fantasy game server, and a fantasy system game server that synchronizes real event game clocks to a master time clock, while determining the points derived by a player during the specific amount of time of play selected by the fantasy operator. The fantasy system allows operators to select players, and or change players at any position or make up of a team for a league or contest so that the performance of the team in the league or contest is a function of the totals of all the specific amounts of time the fantasy operator has selected for use of the players during the real time events. The ability to select or change players in real time obviates the need to draft rosters, and enables the fantasy operator to select from part or all of the available players in the sum of the real time events for the league or contest.

The invention can be used with any real time sporting event or contest participants. For example, participants can include National Football League players, Major League Baseball players, National Basketball Association players, National Hockey League players, Major League Soccer players, Union of European Football Association players, Professional Golf Tour players, or National Association of Sports Car Auto Racing.

The invention can be utilized in a variety of different league configurations. For example, in fantasy football leagues that have teams whose rosters include starters and bench players, the teams can be enabled to make changes in real time during the contests. The fantasy operator can decide to play starters for a specific amount of time, then use the remaining total time available for that position by selecting their bench player for play. The selection and strategy involved in selecting and terminating play of players occur during the real event games the players are playing in.

In another example, a weekly contest is organized by groups of operators. The operators can select or change players for a specific amount of time during the real events. The operator with the most points accumulated at the end of a contest period is the group winner. Group winners can proceed to a winners group for further competition, while the weekly contest resets and begins anew.

In another example, the weekly contests can be daily contests, where the selection or changing of players is allowed during the day of real time events. The selection or changing of players can be for the amount of time equal to one play or a series of plays. The duration of contests can vary from daily to an entire season of real time events.

The aforementioned forms and other forms as well as objects and advantages of the present invention will become further apparent from the following detailed description of various embodiments of the present invention read in conjunction with the accompanying drawings. The detailed description and drawings of the various embodiments of the present invention are merely illustrative of the present invention rather than limiting, the scope of the present invention being defined by the claims and equivalent thereof.

### BRIEF DESCRIPTION OF THE DRAWINGS

FIG. 1 illustrates a block diagram of a basic configuration for the fantasy system

FIG. 2 illustrates a flow chart of operation for synchronization of fantasy system

FIG. 3 illustrates first embodiment of synchronization between master time clock and game time clock

FIG. 4 illustrates second embodiment of synchronization between master time clock and game time clock with same day and multiple game time starts

FIG. 5 illustrates third embodiment of synchronization between master time clock and game time clock with multiple game day and time starts

### DETAILED DESCRIPTION OF THE PRESENT INVENTION

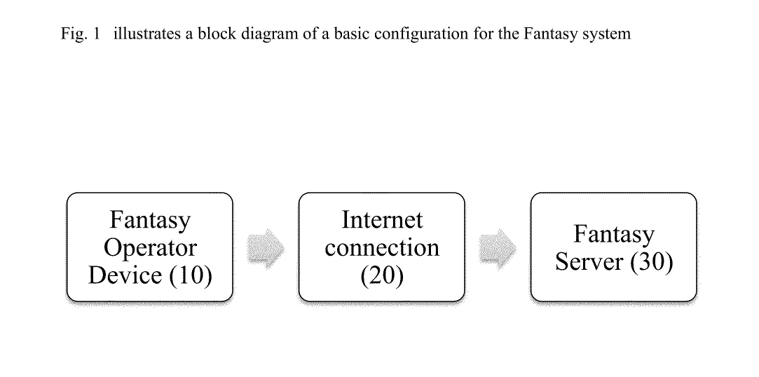

FIG. 1 illustrates The fantasy system block diagram comprising a fantasy operator utilizing a web based or app based device (10), a means to connect (Internet connection) the fantasy operator through the web base or app based device (20), and a fantasy server (30).

For purposes of this invention the term “fantasy operator” is broadly defined herein as a fantasy operator utilizing any type of device to view and manage players in a league or contest in real time. The fantasy operator may use a smart phone, and Internet browser from a computer, laptop, tablet, satellite TV or web enabled TV as the means to view and manage players in a league or contest in real time.

The fantasy operator is connected (20) to the fantasy server through bi directional networking channels. The connection can be through any variety of different types of communication means to connect smart phones, computers, laptops, tablets or TV's to web based or app based network servers. The connection means can include but is not limited to wireless connection, satellite, microwave, fiber optic, cable, modem, or blue tooth. The use of means to connect the fantasy operator results in real time or near real time communications to the fantasy server.

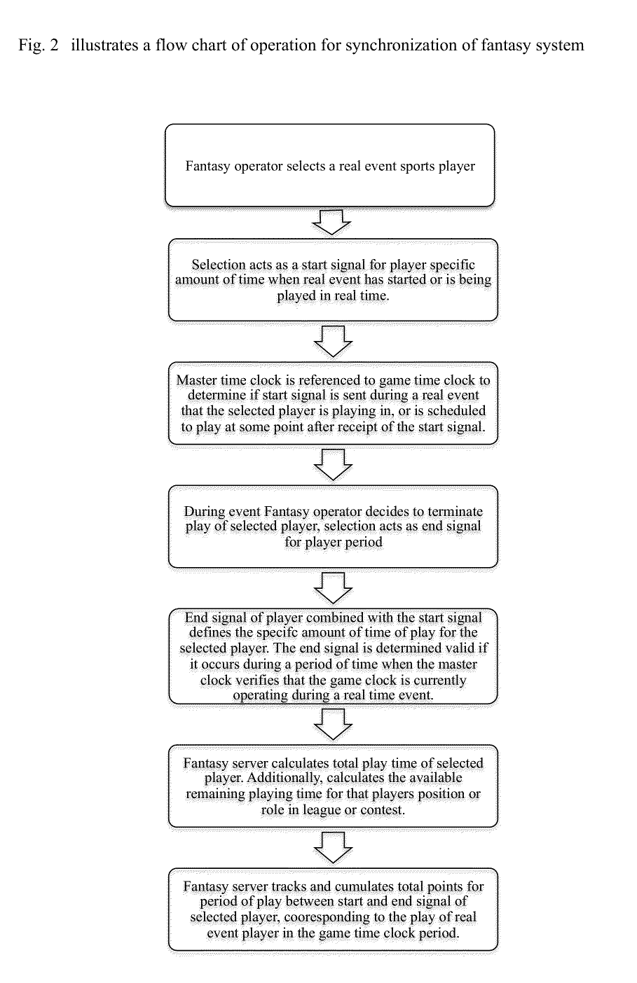

The fantasy server (30) incorporates a number of the operational aspects of the present invention. A new and unique operational aspect of the fantasy server is the generation of a master time clock that is utilized in the synchronization process. FIG. 2 illustrates a flow chart of the operation for synchronization of the fantasy system. The master time clock can be based on a particular time zone and or reference master clock, or it can be internally developed and calibrated to represent the current time of all fantasy operators playing in a league or contest. The master time clock can be one of the game clocks utilized to in a manner solely to verify contemporary status of the start and end signals generated by the fantasy operator.

Prior to the start of play, the master time clock is synchronized to all real event game clocks to be used in the contest. The fantasy server maintains the master time clock and its synchronization to all real event game clocks throughout the contest.

A new and unique operational aspect of the fantasy server is the receiving of player start signals and player end signals from all fantasy operator devices via the communication means. Upon receipt of a player start signal, the fantasy server identifies the game clock of the player selected. The player start and end signals are referenced to the master time clock to verify player eligibility. The fantasy server compares the master time clock, start and end signals and game clocks to ensure that the player selection occurs either during the real event or prior to the start of the real event.

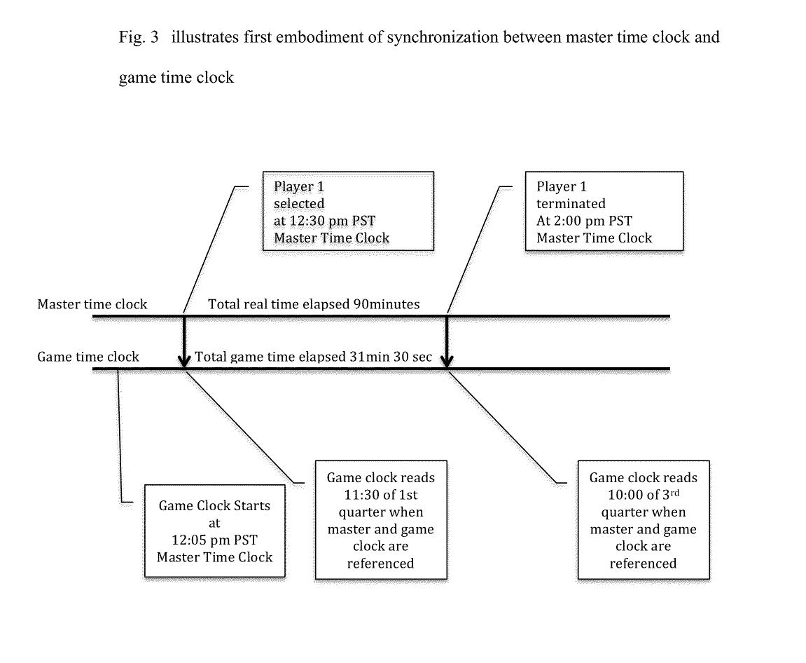

FIG. 3 illustrates an example of how the synchronization between master time clock and game time clock is applied during a single game event. The start time and end time signals occur during a period when the master time clock verifies a real event is in progress. The start and end signals then determine the specific amount of time of player selection by the fantasy operator. The specific amount of player time is a portion of the available total player time for that player position of the fantasy team.

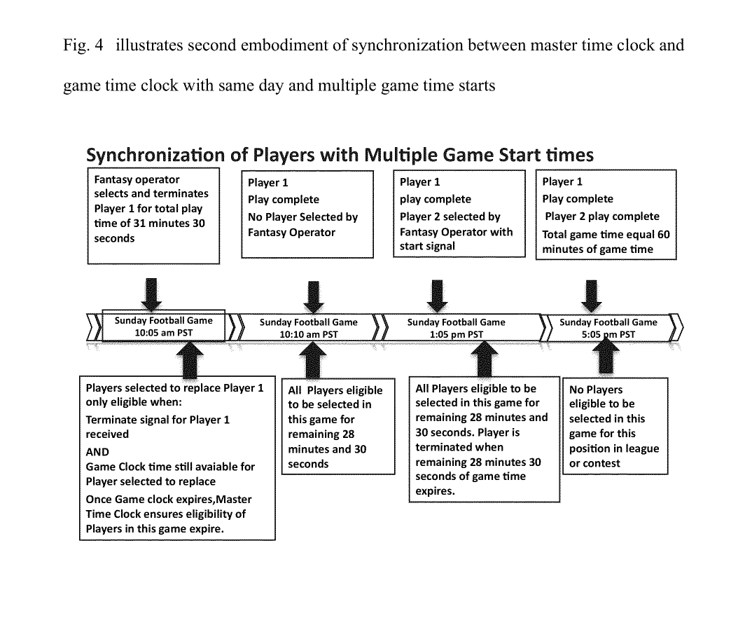

FIG. 4 illustrates how the invention works regardless of different real event start times on a single day. Player 1 is selected in a Thursday night game for a specific amount of player time of 31 minutes and 30 seconds. Player 2, the replacement player is selected during a game that starts at time after the completion of the game in which player one has played in. Player 2 is selected for a specific amount of player time of 28 minutes and 30 seconds. The total player position time in this example is 60 minutes. The total player position time is a function of the fantasy game rules, and could be the length of a game, a portion of a game or several games. The master time clock ensures player selection or replacement occurs during or prior to play in a real event.

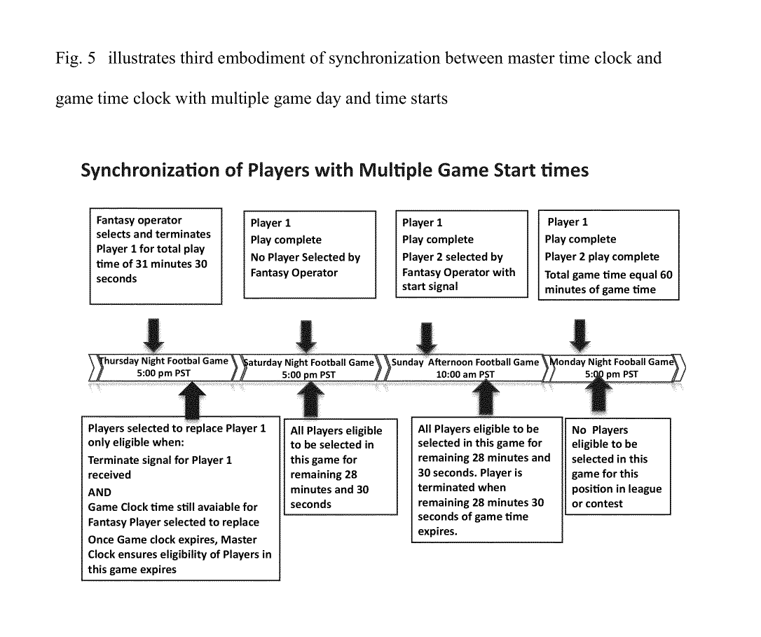

FIG. 5 illustrates how the invention works regardless of different real event start times over different days. The master time clock is synchronized to all real event game clocks during the period of these days. The master time clock ensures player selection or replacement occurs during or prior to play in a real event even when start times for real event games occur over several different times and days.

Another new and unique operational aspect of the present invention is the management of total amount of player time per fantasy player position. Each league or contest may have a variety of different game rules, which are managed by the fantasy server game manager (32). The league or contest rules identify the number of player positions allowed per league game, season or contest. The fantasy server allocates a total amount of game time available per player position allowed in the league or contest. The fantasy server then keeps a real time account of time played per player position, and time available per position for the fantasy operator to utilize. The fantasy operator can select multiple players per position simultaneously and the fantasy server will keep a real time account of time played per player, and time available per position cumulatively. This information is communicated via the communication means to the fantasy operator device for display.

The fantasy server manages the availability of all fantasy players available for selection by the fantasy operator. The fantasy player availability can be determined by a league or contest that requires the drafting of players and rosters. In the case of drafting of fantasy players and rosters for each fantasy operator, the fantasy server manages the total game time availability per player position allowed on each roster by league or contest rules.

A new and unique operational aspect of the present invention is the ability to operate a league or contest without a draft of fantasy players. The ability of fantasy operators to select or change any player by total amount of player time enables the availability of all players for all position to be available for selection.

Additionally, it allows for real time correction of player selection, resulting in more competitive leagues or contests throughout the timeframe of the fantasy games, seasons or contest.

Another unique operational aspect of the fantasy server game manager is the totaling of all game total points scored by the combination of fantasy operator selected specific amounts of player times and the corresponding points accumulated during those specific amounts of times. The type of points accumulated is determined by the league or contest rules. The fantasy server management of specific amount of player time allows for the opportunity to award bonus points at a variety of times during a league or contest.

For example, in a football fantasy league contest, if Peyton Manning is selected, the fantasy operator can be given the opportunity to boost or double all point accumulated by Peyton Manning during the next two minutes of game time play. The awarding of different points per player for specific amounts of time can also act as a means to handicap player selection. The fantasy server communicates the scores to the fantasy operator device for display to the fantasy operator. The fantasy server calculates the order of finish for the fantasy operators based on the league or contest rules.

The fantasy server may delegate some of it's functions, such as point tracking, player management, clock management, fantasy operator alerts to the fantasy operator device with resident app based or web enable programs. The functions of the fantasy server may not change; the location of execution is left to the most efficient means of current computing and networking strategies.

1-20. (canceled)

21. A fantasy sports system, comprising:
a fantasy operator access device;
a fantasy sports server communicatively coupled with the fantasy operator access device, the fantasy sports server configured to:
synchronize a master time clock to a plurality of real-event game time clocks, wherein each of the plurality of real-event game time clocks is associated with a corresponding real-event games;
receive a start signal from the fantasy operator access device, the start signal associated with a selection of a fantasy player in fantasy game, wherein the fantasy player corresponds to at least one real-life player associated with a real-event game from the plurality of real-event games; and
start the selection of the fantasy player in the fantasy game based on an eligibility of the fantasy player, wherein the eligibility of the fantasy player is based on:
the synchronization of the master time clock and the real-event game time clock of the real-event game associated with the at least one real-life player when the start signal is received; and
an available fantasy game time.

22. The system of claim 21, wherein the available fantasy game time corresponds to an available fantasy game time for a player position associated with the fantasy player within a fantasy team.

23. The system of claim 21, wherein the fantasy sports server is further configured to:
update, in real time, the available fantasy game time during the selection of the fantasy player as a function of the real-event game clock of the real-event game associated with the at least one real-life player.

24. The system of claim 23, wherein the fantasy sport server is further configured to terminate the selection of the fantasy player upon the first of:
an expiration of the available fantasy game time; and
a receipt of an end signal from the fantasy operator access device, the end signal associated with terminating the selection of the fantasy player in the fantasy game.

25. The system of claim 23, wherein the fantasy sports server is further configured to:
receive an end signal from the fantasy operator access device, the end signal associated with terminating the selection of the fantasy player in the fantasy game;
terminate the selection of fantasy player in the fantasy game in response to receiving the end signal;
receive a second start signal from the fantasy operator access device, the second start signal associated with a selection of a second fantasy player in the fantasy game, wherein the second fantasy player corresponds to at least one second real-life player in a real-event game from the plurality of real-event games; and
start the selection of the second fantasy player in the fantasy game based on an eligibility of the second fantasy player, wherein the eligibility of the second fantasy player is based on:
the synchronization of the master time clock and the real-event game clock of the real-event game associated with the at least one second real-life player when the second start signal is received; and
the updated available fantasy game time.

26. The system of claim 25, wherein the fantasy sports server is further configured to, in response to the selection of the second fantasy player:
update, in real time, the available fantasy game time during the selection of the second fantasy player as a function of the real-event game clock of the real-event game associated with the at least one second real-life player; and
terminate the selection of the selection of the second fantasy player upon the first of:
an expiration of the available fantasy game time; and
a receipt of a second end signal from the fantasy operator access device, the second end signal associated with terminating the selection of the second fantasy player in the fantasy game.

27. The system of claim 25, wherein the fantasy sports server is further configured to:
calculate a score for the fantasy player as a function of a set of scoring rules of the fantasy game and the selection of the fantasy player; and
calculate a score for the second fantasy player as a function of the set of scoring rules of the fantasy game and the selection of the second fantasy player.

28. The system of claim 27, wherein the set of scoring rules include an increase in scoring for at least one of the fantasy player and second fantasy player based on the selection of the at least of the fantasy player and second fantasy player and a corresponding pre-determined amount of the at least one of a real-time event game associated with the respective fantasy player and second fantasy player.

29. The system of claim 25, wherein at least one of the start signal and the second start signal includes a user-selected amount of selection associated with a corresponding at least one of the fantasy player and second fantasy player, the user-selected amount of selection comprising a duration of the selection as an amount of fantasy game time.

30. The system of claim 25, wherein the real-time event game corresponding to the second fantasy player comprises a second real-time event game different from the real-time event game corresponding to the fantasy player, and wherein the second real-time event game starts after the real-time event game corresponding to the fantasy player has finished.

31. The system of claim 21, wherein the fantasy sports server configured to start the selection of the fantasy player in the fantasy game based on the eligibility of the fantasy player comprises the fantasy sports configured to:
synchronize the master time clock and the real-event game clock of the real-event game associated with the at least one real-life player when the start signal is received by comparing the master clock, a time associated with the receipt of the start signal, and the real-event game clock to verify that the selection of the fantasy player was made prior to the end of the real-event game; and
verify that the available fantasy game time has not expired.

32. The system of claim 21, wherein the at least one real-life player and the plurality of real-event games respectively comprise players and games associated with a professional football league, a professional baseball league, a professional basketball league, a professional hockey league, a professional soccer league, a professional golf tour, or a professional auto racing association.

33. The system of claim 21, wherein the fantasy game comprises a fantasy baseball game, the plurality of real-time event games comprise baseball games, and wherein the plurality of real-time event game clocks comprise a number of outs in a baseball game.

34. The system of claim 21, wherein the fantasy player is selected from a plurality of fantasy players comprising a fantasy team roster.

35. The system of claim 35, wherein the fantasy sports server is further configured to enable a selection of the fantasy team roster as an in-stadium contest.
